(19) United States
(12) Patent Application Publication
(10) Pub. No.: US 2009/0043561 A1
(43) Pub. Date: Feb. 12, 2009

(54) SYSTEM AND A METHOD FOR A MULTI DEVICE EMULATION IN NETWORK MANAGEMENT SYSTEM

(76) Inventors: Guy David Arieli, Even Yehuda (IL); Yoram SHAMIR, Kiryat Ono (IL); Shmuel Shay Zluf, Holon (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/836,167

(22) Filed: Aug. 9, 2007

(51) Int. Cl. G06F 9/455

(52) U.S. Cl. 703/24

(57) ABSTRACT

The present invention is a system and a method of emulating large numbers of network elements to enable testing the operational abilities of NMS devices to scale. According to embodiments of the present invention multiple network elements are emulated by using a single network element while ensuring that all multiple network elements appear to the NMS devices as real network elements The disclosed solution is comprised of an appliance that connects a NMS device to one real network clement. The appliance presents the network element to the NMS device as thousands of network elements with thousands of IP addresses. Using a real network element enables the system to emulate real world SNMP set/get behaviors. The proposed solution enables monitoring the behavior of NMS devices in controlled circumstances and to test their behavior under different load conditions.

### FIELD OF INVENTION

The present invention relates to systems and methods for emulating network elements, more particularly it relates to systems and methods for emulating network elements of network management systems.

### BACKGROUND OF THE INVENTION

Network Management Systems (NMS) use Simple Network Management Protocol (SNMP) to manage networks comprised of a single NMS device and a plurality of network elements. Each network element is identified through a unique Internet Protocol Address (IP address). The NMS device holds a list of tie IP addresses of all network elements. This list is manually defined by an operator or retrieved automatically using a discovery mechanism. Once the NMS device acquires the list of network elements it polls all network elements in predefined time intervals to get their status. Most of the network management traffic is composted of SNMP Requests sent by the NMS device to the network elements, to which the elements reply with an SNMP response. Additionally, network elements can trigger a Trap to the NMS device. A Trap is a single time event initiated by the network element and sent to the NMS device.

Since sometimes NMS operate in networks which are comprised of tens of thousands and even hundreds of thousands of network elements, it is highly important to test their functioning abilities in conditions which are as similar to real world conditions as possible. Known in the art are several systems and methods for emulating networks.

However, none of the existing patents and patent applications discloses a simple and cost effective solution for emulating large quantities of network elements while providing highly reliable emulation of network element behavior. There is therefore a need for a system and a method for testing the operation of NMS devices while emulating networks composed of thousands of network elements which are able to produce highly accurate operational conditions of network elements.

### SUMMARY OF SOME EMBODIMENTS OF THE INVENTION

Disclosed is a system for emulating networks which are comprised of at least one network management device and a plurality of network elements. The system comprised of at least one network emulating appliance and a first communication interface for connecting the appliance to a single network management device and transmitting requests from the network management device to the emulating appliance and responses from the emulating appliance to the network management device. The system also comprises a second communication interface for connecting the appliance to at least one network element and transmitting requests from the emulating appliance to the network elements and responses from the network elements to the emulating appliance. The appliance includes a filtering module for selectively transferring communication messages from the network emulating appliance to the network element.

The first communication interface optionally includes connections to several network management devices and/or network emulating appliances and the second communication interface optionally includes connections to several network elements.

The network elements optionally include different types of network elements. The network emulating appliances are optionally organized in a hierarchical structure. The filtering nodule optionally transfers the communication messages in accordance with predefined conditions which can be defined by a user. The predefined conditions optionally include a message type which is not already cached by the network emulating appliance and optionally also include the timestamp and a counter of the message.

Also disclosed is a method of emulating network behavior comprised of at least one emulating appliance connected to a network management device through a to first communication interface and to at least one network element through a second communication interface. The method comprises the steps of receiving a network communication message from the network management device through a first communication interface and caching the network communication message by the emulating appliance. The method also includes the steps of filtering messages transferal to the network elements through the second communication interface, wherein at least part of the communication messages are transferred to the network element, caching responses received from the network element and transferring an appropriate response to the network communication message through the first network communication interface to the network management device. The response may be a response from a network element or a cached response.

The filtering is optionally determined in accordance with predefined criteria which can be determined by a user and are optionally determined according to the type of the network communication message. The type of message can optionally relate to the level of correspondence between the communication message and previously cached messages by emulation appliance. The predefined criteria can be determined according to the timestamp of the communication message and according to a message counter of the communication messages.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram illustrating the principal network components of operational networks;

FIG. 2 is a block diagram illustrating the types of network communications in operational networks;

FIG. 3 is a block diagram illustrating the principal components of the emulated network in accordance with a first embodiment of the present invention;

FIG. 4 is a flowchart illustrating a simplified example for the operation of the system in accordance to embodiments of the present invention;

FIG. 5 is a block diagram illustrating the principal components of the emulated network in accordance with a second embodiment of the present invention;

FIG. 6 is a block diagram illustrating the principal components of the emulated network in accordance with a third embodiment of the present invention;

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity.

### DESCRIPTION OF SOME EMBODIMENTS OF THE INVENTION

The present invention is a system and method of emulating large numbers of network elements to enable testing the operational abilities of network management devices such as network management systems (NMS) devices to scale. According to embodiments of the present invention multiple network elements are emulated by using a single network element while ensuring that all multiple network elements appear to the NMS devices as real network elements. The disclosed solution is comprised of an appliance that connects a NMS device to one real network element. The appliance presents the network element to the NMS device as thousands of network elements with thousands of IP addresses. This solution is cost effective and easy to configure, while enabling the emulation of networks composed of thousands of network elements. To operate it one simply needs to define the emulated devices IP range, connect the NMS device and at least one network element to the appliance. Using a real network element enables the system to emulate real world SNMP set/get behaviors. The proposed solution enables monitoring the behavior of NMS devices in controlled circumstances and to test their behavior under different load conditions.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The following description relates to Simple Network Management Protocol (SNMP) networks to simplify the explanations and as a way of illustration only. The disclosed system and method can be applied to any type of information network comprised of network management devices and a plurality of network elements.

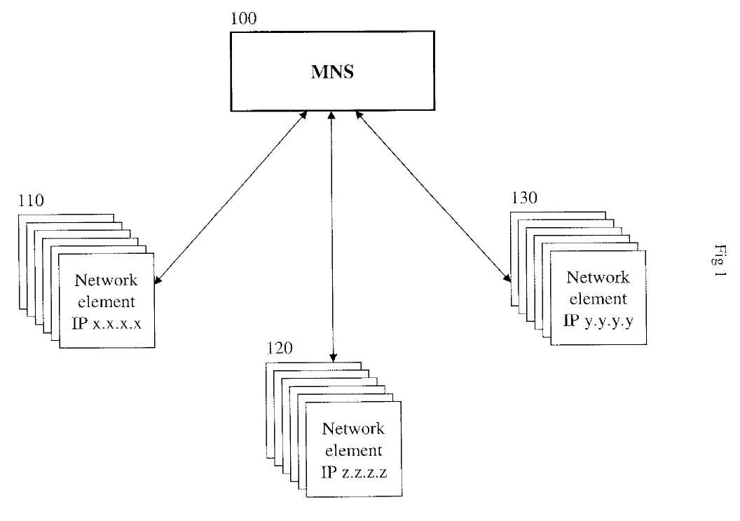

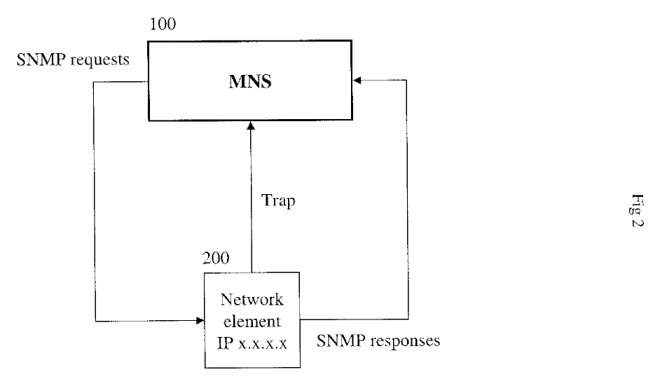

Reference is now made to FIG. 1 which is a block diagram illustrating the principal components of an operational network. As illustrated, NMS device 100 is connected to a large number of network elements 110, 120, 130. NMS device identifies each network element according to its unique IP address. FIG. 2 is a block diagram illustrating the type of communication messages set between the NMS device 100 and the network elements in operational networks. NMS device 100 sends SNMP requests to network element 200. The network element 200 responds by sending a SNMP response to network element 200. Under certain conditions, network element 200 can also trigger a message and send it to the NMS device. This message called a trap.

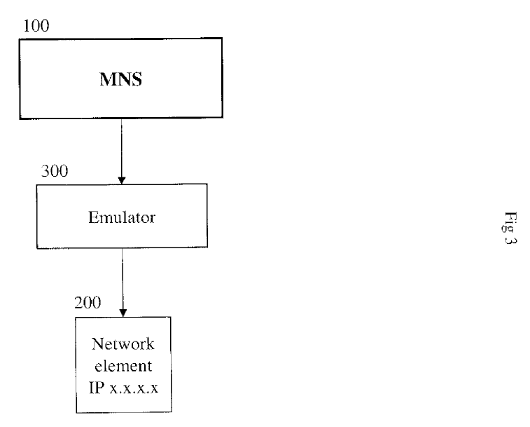

Reference is now made to FIG. 3. FIG. 3 is a block diagram Illustrating the configuration of the system in accordance with a first embodiment of the present invention. According to a first embodiment the system is comprised of a single network emulator appliance 300 with two network interfaces. The first network interface is connected to a single NMS device 100 and the second network interlace is connected to a single network element 200. All communication between NMS device 100 and network element 200 is conducted through appliance 300. Appliance 300 holds thousands of IP addresses on the first network interface. Thus, from the perspective of NMS device 100, the network is comprised of thousands of network elements although in actuality only one network element 200 is connected.

When NMS device 100 sends an SNMP request to any of the IP addresses through the first network interface, the appliance 300 caches the request and redirects it to network element 200 through the second network interface. Appliance 300 then transfers the SNMP respond from network element 200 to NMS device 100. Additionally, the SNMP response is cached by appliance 300, so the next time the same request is send for any emulated device, the appliance sends the cached response without forwarding it to the real device. Thus, the operation of appliance 300 combines the operation of a filtering module which selectively sends requests from NMS device 100 to network element 200. Similarly, according to some embodiments of the present invention appliance 300 combines the operation of second filtering module which selectively sends requests from network element 200 to NMS device 100 according to the configuration of appliance 300.

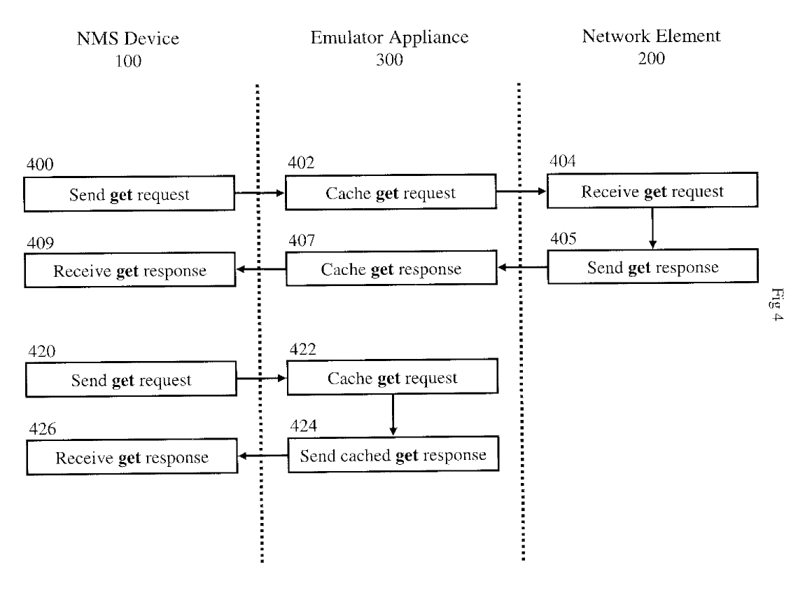

The transaction is cached according to the request object identifier (OID), the get and set method and the request OID count. The following is an example for the operation of the system as illustrated in the flowchart of FIG. 4. NMS device 100 sends get request for a new OID to a first IP address (step 400). The request is cached by appliance 300 (step 402) forwarded to the real network element 200 (step 404). Appliance 300 receives the response from network clement 200 (step 405), caches it (step 407) sends it back to the NMS device 100 (step 409). The cached messages are cached with the OID and a counter. Then, NMS device 100 sends another get request for the same OID for a second IP address (step 420). Appliance 300 caches request (step 422) but does not forwarded to the real device by appliance 300. Instead, appliance 300 sends NMS device 100 the cached response.

Whenever a new type of SNMP request is sent from NMS device 100, appliance 300 forwards it to the real network element 200 to receive the SNMP response. As aforementioned, the SNMP request and SNMP response are cached by appliance 300 and the next time that the same request is received from NMS device 100, the appliance 300 can send the recorded response hack to the NMS device 100 without forwarding it to network element 200. However, appliance 300 is optionally preconfigured to send an incoming SNMP request to the real network element 200 under certain conditions even of the incoming SNMP request is already cached. These conditions are configurable by the user of the system. For instance, the user can configure appliance 300 to send the incoming SNMP request to the network element 200, even if the request and response are already cached, every predefined time interval. Alternatively, the user can configure appliance 300 to send the incoming SNMP request to the network element 200 every predefined incoming request, such as once every hundred requests. Alternatively, the user can configure appliance 300 to send the incoming SNMP request to the network element 200 every time the SNMP request is sent to network appliance with a certain IP address.

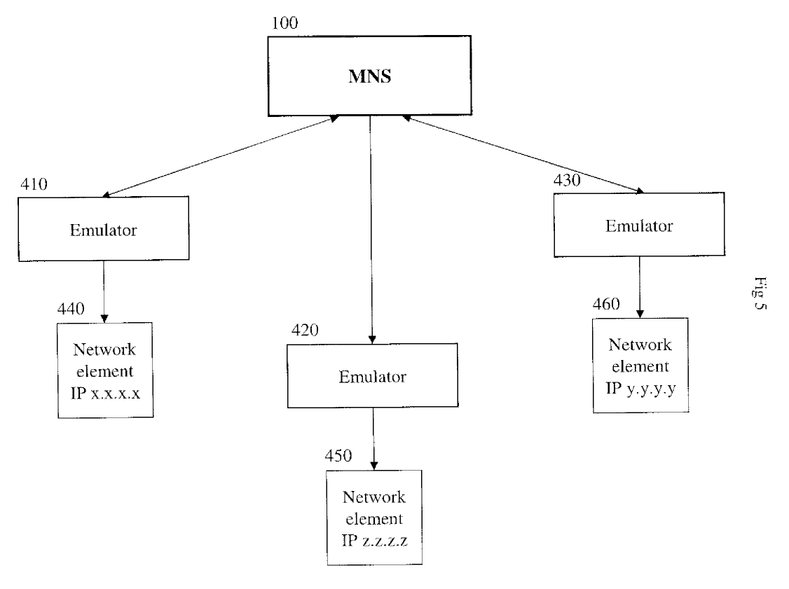

FIG. 5 is a block diagram illustrating the principal components of the disclosed system in accordance with a second embodiment of the present invention. This configuration is comprised of a single NMS device 100 which is connected to several network emulator appliances 410, 420 and 430. This embodiment is suited to emulate a network configuration which is comprised of different kinds of network elements. For this purpose a single network element of each type of network elements in the emulated network is connected to a single network emulator appliance. In the illustrated example the network is comprised of three different types of network elements. Each appliance 410, 420 and 430 is connected to a single network element: appliance 410 is connected to network element 440, appliance 420 is connected to network element 450, and appliance 430 is connected to network element 460. Appliance 410, 420 and 430 are identical and each appliance 410, 420 and 430 holds a range of IP addresses.

The configuration of the second embodiment operates according to a similar method as described in the first embodiment. Each network emulator appliance receives and caches the SNMP requests, transfers a small portion of them to the network element which is connected to it. The responses are also cached and transferred back to the NMS device. The only difference between the first and the second embodiment is that in the second embodiment this process is performed using several emulator appliances, while in the first embodiment it is performed using a single emulator appliance.

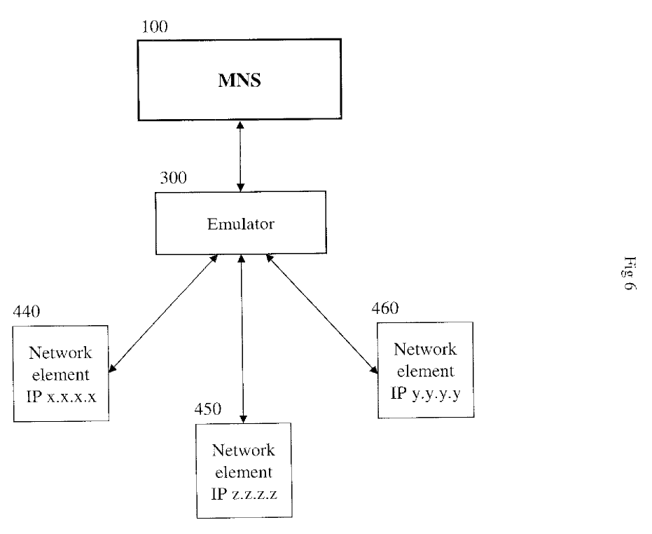

FIG. 6 is a block diagram illustrating the principal components of the disclosed system in accordance with a third embodiment of the present invention. According to a third embodiment a single NMS device 100 is connected to a single emulator appliance 300 through a first network interface. Emulator appliance 300 is connected to several network elements 440, 450 and 460 through a second network interface. Network elements 440, 450 and 460 are optionally different types of network elements. This configuration operates according to the method described in the first embodiment: appliance 300 receives SNMP requests from the NMS device and transfers a small portion of them. However, according to the third embodiment when appliance 300 transfers the requests, it transfers them to one of the network elements 440, 450 and 460 according to the definitions provided by the user.

According to additional embodiments of the present invention the system includes any combination of the second and the third embodiments. These embodiments optionally include a number of network emulator appliances wherein each appliance is connected to one or more network element. The configuration of the system is determined according to the needs of the users of the system and may emulate complex network configurations. According to some embodiments the emulator appliances are optionally connected in a hierarchic configuration.

All embodiments of the present invention also include user interfaces through which the users of the system can install and configure the emulated network. Using the user interfaces the users of the system define setup configuration such as the IP addresses range of each of the emulator appliance and the types of network elements connected to each of the emulator appliances. Additionally, users can define network conditions for testing the behavior of the NMS device in different circumstances. For instance, users can define the load balance of the network. Users can also optimize the rate and conditions under which the requests are sent by the emulator appliances to the actual network elements according to the needs of the system. Through the users interface users can also extract reports showing the behavior of the NMS device in the tested conditions. The system optionally also includes an Application Program Interface (API) to enable external programs to extract system status and statistics as well as to configure the system.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system for emulating networks which are comprised of at least one network management device and a plurality of network elements, said system comprised of:
at least one network emulating appliance;
a first communication interface for connecting said appliance to a single network management device and transmitting requests from said network management device to said emulating appliance and responses from said emulating appliance to said network management device; and
a second communication interface for connecting said appliance to at least one network element and transmitting requests from said emulating appliance to said network elements and responses from said network elements to said emulating appliance;
wherein said appliance includes a filtering module for selectively transferring communication messages from said network emulating appliance to said network element

2. The system of claim 1 wherein said second communication interface includes connections to several network elements.

3. The system of claim 1 wherein said first communication interface includes connections to several network emulating appliances.

4. The system of claim 1 wherein said first communication interface includes connections to several network management appliances.

5. The system of claim 1 wherein said network elements include different types of network elements.

6. The system of claim 1 wherein said network emulating appliances are organized in a hierarchical structure.

7. The system of claim 1 wherein said filtering module transfers said communication messages in accordance with predefined conditions.

8. The system of claim 7 wherein said predefined conditions are defined by a user.

9. The system of claim 7 wherein said predefined conditions include a message type which is not already cached by said network emulating appliance.

10. The system of claim 7 wherein said predefined conditions include the timestamp of said message.

11. The system of claim 7 wherein said predefined conditions include a counter of said message.

12. The system of claim 7 wherein said predefined conditions are defined through an Application Program Interlace (API).

13. The system of claim 1 further including a second filtering module for selectively transferring communication messages from said network emulating appliance to said network management device.

14. A method of emulating network behavior comprised of at least one emulating appliance connected to a network management device through a first communication interface and to at least one network element through a second communication interface, said method comprising the steps of:
receiving a network communication message from said network management device through a first communication interface;
caching said network communication message by said emulating appliance;
filtering messages transferal to said network elements through said second communication interface wherein at least part of said communication messages are transferred to said network element;
caching responses received from said network element;
transferring all appropriate response to said network communication message through said first network communication interface to said network management device wherein said response is at least one of the following: a response from a network element, a cached response.

15. The method of claim 14 wherein said filtering is determined in accordance with predefined criteria

16. The method of claim 15 wherein said predefined criteria are determined by a user.

17. The method of claim 15 wherein said criteria are determined according to the type of said network communication message.

18. The method of claim 17 wherein said type relates to the level of correspondence between said communication message and previously cached messages by emulation appliance.

19. The method of claim 14 wherein said predefined criteria are determined according to the timestamp of said communication message.

20. The method of claim 14 wherein said predefined criteria are determined according to a message counter of said communication messages.
